(19) United States
(12) Patent Application Publication
(10) Pub. No.: US 2012/0290288 A1
(43) Pub. Date: Nov. 15, 2012

(54) Parsing of text using linguistic and non-linguistic list properties

(75) Inventor: Salah Aït-Mokhtar, Meylan (FR)

(73) Assignee: Xerox Corporation, Norwalk, CT (US)

(21) Appl. No.: 13/103,263

(22) Filed: May 9, 2011

(51) Int. Cl. G06F 17/27

(52) U.S. Cl. 704/9

(57) ABSTRACT

A system and method are disclosed for extracting information from text which can be performed without prior knowledge as to whether the text includes a list. The method applies parser rules to a sentence spanning lines of text to identify a set of candidate list items in the sentence. Each candidate list item is assigned a set of features including one or more non-linguistic feature and a linguistic feature. The linguistic feature defines a syntactic function of an element of the candidate list item that is able to be in a dependency relation with an element of an identified candidate list introducer in the same sentence. When two or more candidate list items are found with compatible sets of features, a list is generated which links these as list items of a common list introducer. Dependency relations are extracted between the list introducer and list items and information based on the extracted dependency relations is output.

### BACKGROUND

The exemplary embodiment relates to natural language processing and finds particular application in connection with a system and method for processing lists occurring in text.

Information Extraction (IE) systems are widely use for extracting structured information from unstructured data (texts). The information is typically in the form of relations between entities and/or values. For example, from a piece of unstructured text such as “ABC Company was founded in 1996. It produces smartphones,” an IE system can extract the relation <“ABC Company”, produce, “smartphones”>. This is performed by recognizing named entities (NEs) in a text (here, “ABC Company”), and then building up relations which include them, depending on their semantic type and the context.

Some IE systems only rely on basic features such as co-occurrence of the entities within a window of some size (measured in the number of words inside the window). More sophisticated systems rely on parsing, i.e., the computation of syntactic relations between words and/or NE constituents. Such systems generally use statistically-based or rule-based robust parsers that process the input text to identify tokens (words, numbers, and punctuation) and then associate the tokens with lexical information, such as noun, verb, etc. in the case of words, and punctuation type in the case of punctuation. From these basic labels, more complex information is associated with the text, such as the identification of named entities, relations between entities and other parts of the text, and coreference resolution of pronouns (such as that “it” refers to ABC Company in the above example). The linguistic processing produces syntactic relations like subject, direct object, modifier, etc. These relations are then transformed into semantic relations depending on the semantic classes of the NEs (such as Person name, Organization name, Product name) or of the words that they link. Hence, syntactic relations can be seen as strong conditions on the extraction of semantic relations, i.e., structured information.

One problem which arises is that even a robust parser is designed to process only regular, continuous texts, such as the texts of most newspaper articles or newswires. Regular continuous texts are sequences of syntactically self-contained sentences that are expected to end with a strong punctuation (usually a period, exclamation mark or question mark, although sometimes a colon or semi-colon is considered). For instance, syntactically annotated corpora that are widely available for English and used as training data for statistical parsers mainly consist of newspaper articles where lists are not frequent. Parsers are thus designed without consideration to portions of texts with irregular logical structure or layout, such as enumerated lists. Lists, however, tend to occur more frequently in some documents (e.g., court decisions, technical manuals, scientific publications) and the existing parsers have difficulties (which appear as errors and/or silences) in parsing them. Manual cleaning of such documents may thus be employed as a preprocessing step, before a parser can be applied.

Lists can have a variety of structures. Some are highly structured, with item labels and so forth. In many cases, however, list structures are not as explicitly marked in texts with unambiguous symbols or tags. There are various reasons for this. For example, the text can be written in a simple editor without list formatting capabilities, the text may have been produced by an optical character recognition OCR system, the text can be written with a text processor without employing the software list-specific formatting capabilities, or the text can be exported from a PDF or text processor document as raw text and the list structure marks may be lost in the process.

Ambiguity also arises because most list labels are not unique to lists. Some lists, for example, use alphabetic or numeric labels to start their list items, but these labels can have other roles, such as initials of a person's name, or as numerical values, etc. Some lists have their list items introduced with punctuation marks that have other usages (e.g., hyphens and period marks). In other lists, list items do not have any labels and/or may begin with lowercase letters, and hence there may be a tendency for them to be confused with any other kind of word sequence. As a consequence, extracting semantic information from lists can be difficult.

There remains a need for a system and method for automated processing of text which can extract semantic relations from lists.

### INCORPORATION BY REFERENCE

The following references, the disclosures of which are incorporated herein in their entireties, by reference, are mentioned:

The following relate to linguistic parsing: S. Aït-Mokhtar, J.-P. Chanod, and C. Roux, “Robustness beyond shallowness: incremental deep parsing,” in Natural Language Engineering 8, 3, 121-144, Cambridge University Press (June 2002), hereinafter Aït-Mokhtar 2002; S. Aït-Mokhtar, V. Lux, and E. Banik, “Linguistic Parsing of Lists in Structured Documents,” in Proc. 2003 EACL Workshop on Language technology and the Semantic Web (3rd Workshop on NLP and XML, NLPXML-2003), Budapest, Hungary (2003); and U.S. Pat. No. 7,058,567, issued Jun. 6, 2006, entitled NATURAL LANGUAGE PARSER, by Salah Aït-Mokhtar, et al.

U.S. Pat. No. 7,797,622, issued Sep. 14, 2010, entitled VERSATILE PAGE NUMBER DETECTOR, by Hervé Déjean, and U.S. Pub. No. 20100306260, published Dec. 2, 2010, entitled NUMBER SEQUENCES DETECTION SYSTEMS AND METHODS, by Hervé Déjean, relate to the detection of numbering schemes in documents.

Extraction and processing of named entities in text is disclosed, for example, in U.S. Pub Nos. 20100082331, 20100004925, 20090265304, 20090204596, 20080319978, and 20080071519.

### BRIEF DESCRIPTION

In accordance with one aspect of the exemplary embodiment, a method for extracting information from text without includes providing parser rules adapted to processing of lists in text and a computer processor for implementing the parser rules. Each list includes a plurality of list items linked to a common list introducer. The method include receiving text from which information is to be extracted, the text including lines of text. For one of the sentences, with the parser rules, provision is made for identifying a set of candidate list items in the sentence, each candidate list item being assigned a set of features. The features include a non-linguistic feature and a linguistic feature. The linguistic feature defines a syntactic function of an element of the candidate list item that is able to be in a dependency relation with an element of an identified candidate list introducer in the sentence. A list is generated which includes a plurality of list items. This includes identifying list items from the candidate list items which have compatible sets of features, and linking the list items to a common list introducer. Dependency relations between an element of the list introducer and a respective element of each of the plurality of list items of the list and information is output, based on the extracted dependency relations.

In accordance with another aspect of the exemplary embodiment, a system for processing text includes a syntactic parser which includes rules adapted to processing of lists in text, each list including a list introducer and a plurality of list items. The parser rules including rules for, without prior knowledge as to whether the text includes a list, identifying a plurality of candidate list items in a sentence. Each candidate list item is assigned a set of features, the features including a non-linguistic feature and a linguistic feature. The linguistic feature defines a syntactic function of an element of a respective candidate list item that is able to be in a relation with an element of a candidate list introducer in the sentence. The rules generate a list from a plurality of list items with compatible feature sets. A processor implements the parser.

In accordance with another aspect of the exemplary embodiment, a method for processing text includes for a sentence in input text, providing parser rules for identifying candidate list items in the sentence. Each candidate list item includes a line of text and an assigned set of features. The features in the set include a plurality of non-linguistic features and a linguistic feature. The linguistic feature defines a dependency relation between an element of the candidate list item and an element of a candidate list introducer in the same sentence. The rules generate a tree structure which links a list introducer to a plurality of list items, the list items selected from the candidate list items based on compatibility of the respective sets of features. The rules are implemented on a sentence with a computer processor.

### BRIEF DESCRIPTION OF THE DRAWINGS

FIG. 1 is an illustration of a text document including a list and a sub-list;

FIG. 2 is a functional block diagram of a system for extracting information from lists in text in accordance with one aspect of the exemplary embodiment;

FIG. 3 is a functional block diagram of a method for extracting information from lists in text in accordance with another aspect of the exemplary embodiment;

FIG. 4 illustrates an exemplary tree structure including list item nodes;

FIG. 5 illustrates the exemplary tree structure including a list node and list item nodes; and

FIGS. 6-8 illustrate exemplary parser rules.

### DETAILED DESCRIPTION

Aspects of the exemplary embodiment relate to a system and method for extracting information from lists in natural language text.

A list can be considered as including a plurality of list constituents including a “list introduction,” which precedes and is syntactically related to a set of two or more “list items.” Each list item may be denoted by a “list item label,” comprising one or more tokens, such as a letter, number, hyphen, or the like, although this is not required. List items can have one or more layout features representing the geometric structure of the text, such as indents, although again this is not required. A list can include many list items and span over several pages. A list can contain sub-lists, each of which has the properties of a list. A list may also contain one or more list item modifiers, each of which links subsequent list items to the list introduction, without being a continuation or sub-list of a previous list. A list can be graphically represented by a list structure, e.g., in the form of a tree structure. An “element” of a list can be any text string in a list which is shorter than a sentence, such as a word, phrase, number, or the like, and is generally wholly contained within a respective list item or list introduction. A “main element” is an element of a list constituent which is identified as such by general parser rules. In general, one main element of a list item is the syntactic head of the sequence of words in the list item. For example, if the list item is a finite verb clause with a main finite verb, then the latter is the main element; if the list item is an infinitive or present participle verbal clause, then the infinitive or present participle verb is the main element; if the list item is a prepositional or noun phrase, then the main element is the nominal head of the phrase.

The exemplary method includes extracting syntactic (and, in some cases, semantic) dependency relations (“relations”) which exist between elements of such a list. These relations may include an (active) element from the list introduction as one side of the relation and another (main) element from a respective list item on the other side of the relation. An active element of a list introduction can be any element that is not syntactically exhausted, i.e., it lacks at least one syntactic relation (in linguistic terms, it is missing a syntactic head or dependent). An active element can be the main element in the list introduction, although is not necessarily so. The extracted relations allow an IE system to capture the information carried by these relations. The system and method rely on a modified linguistic parser which is able to recognize the list structure and to capture the syntactic relations that hold between the list introduction and the list items.

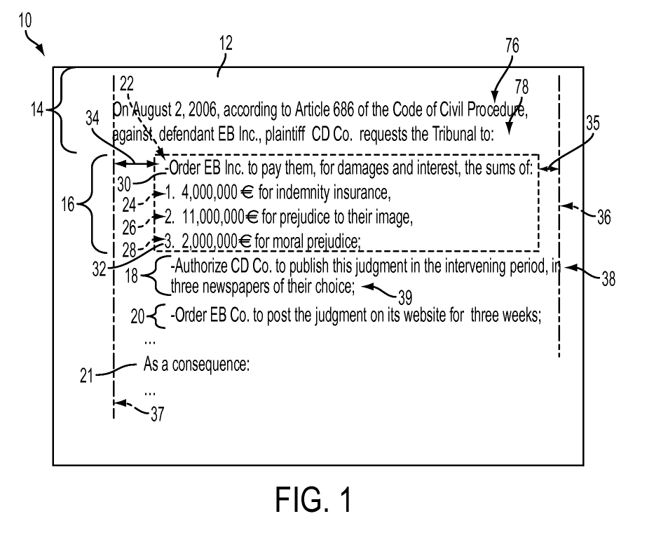

An example of a page of a text document (“document”) 10 comprising a list 12 which may be processed by the exemplary system is shown in FIG. 1. The document 10 can be any digital text document in a natural language, such as English or French, which can be processed to extract the text content, such as a word, PDF, markup language (e.g., XML), scanned and optical character recognition (OCR) processed document, or the like.

The list 12 is in the form of a single sentence and includes a list introduction 14, a plurality of list items 16, 18, 20, etc., and (optionally) a list item modifier 21. List item 16, in this case, serves as a sub-list comprising a (sub)list introduction 22 and three (sub)list items 24, 26, 28. The list items have several features in common. List items 16, 18, 20 are each introduced by the same list item label 30 (a non-linguistic feature), which in this case, is a hyphen. The first character following the list item label 30 in each case is a capital (upper case) letter. The list items 16, 18, 20 also terminate with the same punctuation (here, a semicolon), except for the last list item (not shown) which ends with a period. Sub-list items 24, 26, 28 are each introduced by the same type of list item label 32. In this case, the list item label is different from label 30. Specifically, sub-list items 24, 26, 28 have the same type of list item label (a number followed by a period symbol, such as “1.”). Sub-list items 24, 26, 28 each terminate with the same punctuation (here, a comma), except for the last list item which ends with a semicolon since it terminates the first list item 16. List items 16, 18, 20 have the same layout feature: a left margin indent 34 of 6 character spaces. Sub-list items 24, 26, 28 also have the same layout feature in common: a left margin indent 34 of 6 characters on the first line of each. List items may also have similar right margin indents as shown for the sub list items at 35. The list items 16, 18, 20 also have a linguistic feature in common, in this case, an infinitive verb as its head (or main element) which relates to the active element in the list introduction. Similarly, the sub-list items 24, 26, 28 have a linguistic feature in common: a noun phrase (here, an amount of money), which is a complement of the noun phrase (the sums) in the sub-list introduction 22. Some list items may span more than one line or more than one page. For example, list item 18 includes two lines 38, 39.

While FIG. 1 illustrates an example of a highly structured list 12, it is to be appreciated that lists may have fewer, more, or different features.

The layout features (left and right indents), list item labels, such as punctuation, letters, numbers, other list item starters such as initial letter case, and optionally list item terminators (e.g., punctuation), are all examples of non-linguistic features which, the exemplary system can employ, in association with linguistic features, to identify lists.

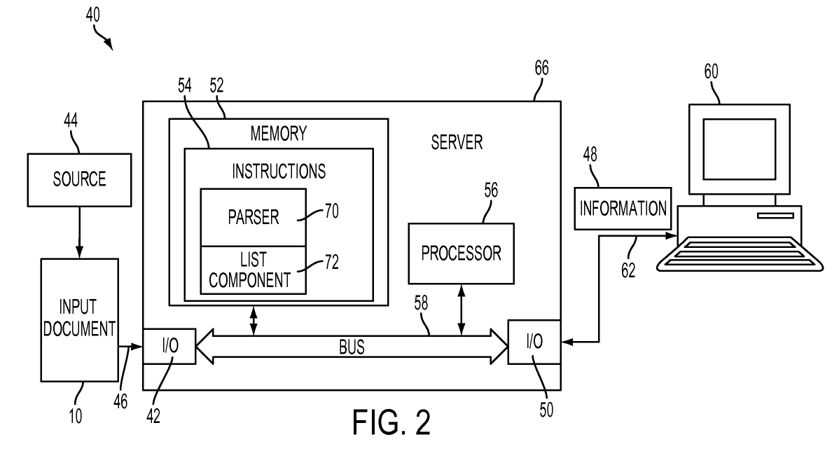

An information extraction (IE) system 40 in accordance with the exemplary embodiment is illustrated in FIG. 2. The system 40 receives, via an input (I/O) 42, a document 10 from a source 44 of such documents, such as a client computing device, memory storage device, optical scanner with OCR processing capability, or the like, via a link 46. Alternatively, document 10 may be generated within the system. The system outputs information 48, such as semantic relations, which have been extracted from text of the document 10, or information based thereon, via an output device (I/O) 50, which can be the same or different from input device 42. System memory 52 stores instructions 54 for performing the exemplary method, which are implemented by an associated processor 56, such as a CPU. Components 42, 50, 52, 56 of the system 10 are communicatively connected by a system bus 58. System 10 may be linked to one or more external devices 60, such as a memory storage device, client computing device, display device, such as an LCD screen or computer monitor, printer, or the like via a suitable link 62. Interface(s) 42, 50 allow the computer to communicate with other devices via a computer network and may comprise a modulator/demodulator (MODEM). Links 46, 62 can each be, for example, a wired or wireless link, such as a plug in connection, telephone line, local area network or wide area network, such as the Internet. System 40 may be implemented in one or more computing devices, such as the illustrated server computer 66.

The memory 52 may represent any type of non-transitory computer readable medium such as random access memory (RAM), read only memory (ROM), magnetic disk or tape, optical disk, flash memory, or holographic memory. In one embodiment, the memory 52 comprises a combination of random access memory and read only memory. Memory 52 stores instructions for performing the exemplary method as well as the input document 10, during processing, and processed data 48. In some embodiments, the processor 56 and memory 52 may be combined in a single chip.

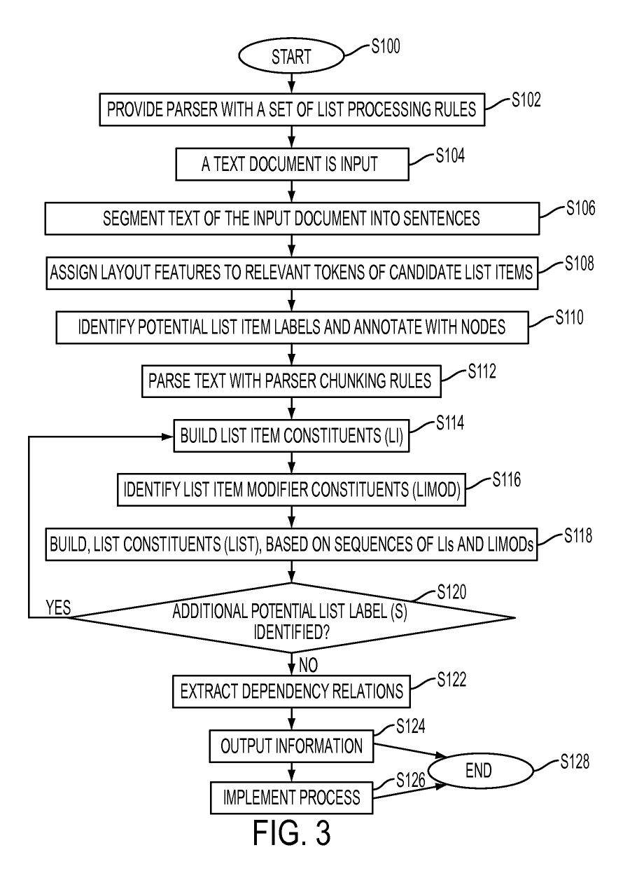

The digital processor 56 can be variously embodied, such as by a single-core processor, a dual-core processor (or more generally by a multiple-core processor), a digital processor and cooperating math coprocessor, a digital controller, or the like. The digital processor 56, in addition to controlling the operation of the computer 66, executes the instructions 54 stored in memory 52 for performing the method outlined in FIG. 3.

The term “software” as used herein is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The exemplary instructions 54 include a syntactic parser 70, which applies a set of rules, also known as a grammar, for natural language processing (NLP) of the document text. In particular, the parser 70 breaks down the input text, including any lists 12 present, into a sequence of tokens, such as words, numbers, and punctuation, and associates lexical information, such as parts of speech (POS), with the words of the text, and punctuation type with the punctuation marks. Words are then associated together as chunks. Chunking involves, for example, grouping words of a noun phrase or verb phrase around a head. Syntactic relations between chunks are extracted, such as subject/object relations, modifiers, and the like. Named entities, which are nouns which refer to an entity by name, may be identified and tagged by type (such as person, organization, date, etc.). Coreference may also be performed to associate pronouns with the named entities to which they relate. The parser 70 may apply the rules sequentially and/or may return to a prior rule when new information has been associated with the text,

The exemplary parser 70 also includes or is associated with a list component 72 comprising rules for processing lists in text. The exemplary parser 70 with list component 72 address the problem of linguistic parsing of labeled or unlabeled lists in text documents, by recognition of the constituent parts of a list (mainly, the list introduction and list items, and optionally a list item modifier 21, where present) and the recognition of the syntactic relations (subject, object, verbal or adjectival modifier, etc.) that relate elements from different parts of the list.

The list component 72 of the system 40 can be implemented as a sub-grammar of the parser 70, for dealing with list structures, without changing the standard core grammar of the parser. The list component 72 includes a set of rules for identifying the list constituents (such as list introduction 14, list items, 16, 18, 20, sub-list introduction 22, sub-list items 24, 26, 28, and list item modifier 21, if any) of a list 12 in the otherwise unstructured text of a document 10, where present. This enables extraction of information 48 from the list constituents by execution of the previously described parser rules.

The exemplary method may be implemented in any rule-based parser 70. However, incremental/sequential parsers are more suitable because they allow for modularity: the sub-grammar 72 dedicated to parsing lists can be in distinct files from the standard grammar 70, allowing it to be developed and maintained without modifying the core grammar 70.

An exemplary parser is a sequential/incremental parser, such as the Xerox Incremental Parser (XIP). For details of such a parser, see, for example, U.S. Pat. No. 7,058,567 to Aït-Mokhtar, et al.; Aït-Mokhtar, S., Chanod, J.-P. and Roux, C. “Robustness beyond shallowness: incremental deep parsing,” in Natural Language Engineering, 8(3), Cambridge University Press, pp. 121-144 (2002). Similar incremental parsers are described in Aït-Mokhtar, et al., “Incremental Finite-State Parsing,” Proceedings of Applied Natural Language Processing, Washington, April 1997; and Aït-Mokhtar, et al., “Subject and Object Dependency Extraction Using Finite-State Transducers,” Proceedings ACL'97 Workshop on Information Extraction and the Building of Lexical Semantic Resources for NLP Applications, Madrid, July 1997. The syntactic analysis may include the construction of a set of syntactic relations (dependencies) from an input text by application of a set of parser rules. Exemplary methods are developed from dependency grammars, as described, for example, in Mel'\check{a}uk I., “Dependency Syntax,” State University of New York, Albany (1988) and in Tesnière L., “Elements de Syntaxe Structurale” (1959) Klincksiek Eds. (Corrected edition, Paris 1969).

Referring once again to the document 10 shown in FIG. 1, by way of example, the system 40 is able to extract the information that one of CD Co.'s requests to the court is that EB Co. is ordered to post the judgment on its website. To extract this information, the parser 70 captures the syntactic relation of Indirect Complement between the verb phrase “request”, for which “CD Co.” is the subject in the list introduction 14, and the verb phrase “Order . . . ” in the third list item 20 of the list 12. To enable such information to be extracted, the parser determines that this verb phrase is the main syntactic element of a list item that is part of a list introduced by a clause, the main verb of which is “request.” The parser takes into account the list's structure to allow this.

The exemplary rule-based method and system extract list structures and the syntactic relations that they bear from both linguistic features and non linguistic features, such as punctuation, typography and layout features. The rules (e.g., as patterns which accept alternative configurations) for identifying non-linguistic features are expressed in the same grammar formalism used for the linguistic features. A given recognition pattern may make use of one or both kind of features. The recognition of list structure and linguistic structure is performed with the same algorithm and in the same parsing process, so that list parsing decisions can rely on linguistic structures and vice-versa. The exemplary method enables automated extraction of information from lists, avoiding the need for the text to be handled by manual or automatic cleaning and formatting of the input text in a separate preprocessing phase.

The exemplary method is illustrated in FIG. 3. The method begins at S100.

At S102, parser rules 72 adapted to processing of lists in text are provided.

At S104, a text document 10 is input to the system 40. The document may include a list, but at the time of input, this is not known to the system. The document may be converted to a suitable format for processing, such as to an XML document.

At S106, the text 10 is tokenized into a sequence of tokens to identify string tokens, such as words, numbers, and punctuation. The sequence of tokens is segmented into sentences so that the introduction of a list and all its items (including any sub-lists) are included in the same single “sentence.” An extended definition of a sentence may be employed in this step. As will be appreciated, the system 40 has not yet identified, at this stage, whether or not a given sentence includes a list.

In the next steps, candidate list items are then identified and associated with a respective set of features which includes one or more non-linguistic features and at least one linguistic feature (S108-S114).

Specifically, at S108, layout features, such as left margin, right margin, are assigned to relevant sentence tokens of candidate list items.

At S110, potential starters (labels) of candidate list items are identified and annotated with non-linguistic features. The starters include potential alphanumeric labels, punctuation, and/or other tokens which may start a list item. The potential starters are assigned additional features such as one or more of the typographical case of the next word (lower/upper case), punctuation mark if any (hyphen, bullet, period, asterisk, etc.), label type if any (number, letter, and/or Roman numeral), and label typographical case when the label type is letter or Roman numeral.

At S112, the text is parsed with a set of parser chunking rules 70 to identify chunks. This includes associating lexical information with tokens of the text (such as verb, noun, adjective, etc.) and identifying chunks: noun phrases (NP), verb phrases (VB), prepositional phrases (PP), etc.

At S114, candidate list items (LI) are built. Each LI inherits the layout features identified at S108 and features from the corresponding list item label(s) identified at S110. In addition to these non-linguistic features, each LI includes at least one linguistic feature which is based on a syntactic relation between an element of the list item and an element of a candidate list introducer.

At S116, list item modifiers (LIMOD) may be identified, in order to handle temporary breaks in lists, for example when a list of causes of action is followed by “In consequence:” then a new set of list items reciting the damages and other reparations requested.

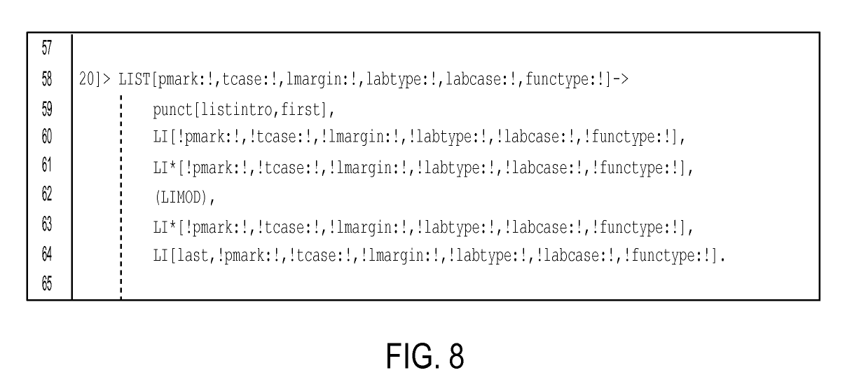

At S118, constituents of lists (LIST) are built, based on sequences of LIs identified at S114 that have compatible linguistic and non-linguistic features, and on contextual conditions. Contextual conditions are conditions on elements before or after a sequence of LIs. For example, the LIST rule in FIG. 8 requires that the sequence of LIs be preceded by a punctuation node. This refers to the punctuation symbol that ends a list introduction. In English, this is often a colon. LIMODs identified at S116 may also be included.

At S120, if more than one type of label is identified, the method returns to S114 to handle the case of lists with embedded sub-lists (starting with the most embedded list first at S114), otherwise to S122.

At S122, for each LIST constituent, the following dependency relations may be extracted:

a. dependency relations between an active element of the list introduction and the main element(s) of each of its list items (LIs); and

b. (optionally) a dependency relation between the LIMOD main element(s) and an active element of the list introduction, or the LIMOD element and the main element of each list items that follow in the same list.

At S124, information 48 based on the extracted relations is output.

At S126, a further process may be implemented, based on the information, such as automatic classification of a document, e.g., as responsive or not responsive to a query, ranking a set of documents based on information extracted from them, or the like.

The method ends at S128.

Each of steps S106-S122 may be performed within the NLP parser 70, 72 using its grammar rule formalism.

As will be appreciated, the steps of the method need not all proceed in the order illustrated and fewer, more, or different steps may be performed.

The exemplary method for linguistic parsing of lists in texts is advantageous in that:

1. The recognition of list structures and linguistic structures involving linguistic features is performed with the same algorithm and in the same parsing process, so that list parsing decisions can rely on linguistic structures and vice-versa;

2. Parsing the list structure is based on both linguistic and non-linguistic features;

3. The non-linguistic features are expressed in the same grammar formalism that is used for linguistic parsing and, thus, a grammar rule can make use of both kinds of feature-linguistic and non-linguistic, including layout features.

The method illustrated in FIG. 3 may be implemented in a computer program product that may be executed on a computer. The computer program product may be a non-transitory computer-readable recording medium on which a control program is recorded, such as a disk, hard drive, or the like. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the method for extracting information from lists in text.

The following give details on aspects of the system and method.

Segmentation of Text into Sentences (S106)

Standard parsers consider that occurrences of strong punctuation, such as “.”, “?” and “!”, and sometimes colon and semicolon, indicate ends of sentences. Such parsers may require that a non lowercase letter follow these punctuation marks before splitting the input text into a sentence (e.g., for European languages). In both cases, the segmentation of a list, such as the one in FIG. 1, would split the list into several sentences. The parser would thus not have the opportunity to capture the syntactic relations between the list elements.

To overcome this problem, the exemplary parser 70 employs splitting rules which apply a different set of conditions for splitting sentences. In the case of a strong punctuation mark being found, a sentence split is not generated when the strong punctuation mark is the first printable character of the line. Nor is a sentence split generated when the strong punctuation mark is immediately preceded by a label (generally, a roman or regular number, or uppercase or lowercase letter) and that such label is the only token occurring between the beginning of the current line and the strong punctuation mark under consideration (see, for example, line 24, which begins: 1. Authorize CD Co . . . ). Additionally, for a split, the strong punctuation mark must be followed by a newline character (such as a paragraph mark or manual line break) or a non lowercase character (such as an upper case character or a number). These conditions provide sentence segmentation which is better than the standard sentence segmentation, based on an evaluation on one corpus studied, although it does not always provide correct segmentation, for example, on lists where the list items contain standard sentences separated with period marks. Once any lists have been extracted, the remainder of the text (unstructured text) can optionally be reprocessed with standard sentence segmentation techniques.

### Identification of Layout Features (S108)

Once a sentence 12 is segmented from the input text, some of its tokens are assigned layout features. This step is performed without knowing whether the sentence is likely to contain a list. For example, the first token on a line and optionally the last token on a line may each be assigned a layout feature: lmargin (left margin) and rmargin (right margin), respectively, which is a measure of a horizontal (i.e., parallel to the lines of text) indent from the respective margin. The value of the lmargin feature can be computed according to the distance between the beginning of a line and the beginning of the first printable symbol/token in that line, e.g., in terms of number of character spaces or an indent width. This information is readily obtained from the document.

The value of the rmargin feature can be the difference between a standard line length and the right offset of the right token, in terms of a number of character spaces. The standard line length may be a preset value, such as 70 characters (which includes any left margin indent). Or it may be computed based on analysis of the text to obtain the longest line. This method is particularly useful when the text is right justified. In other embodiments, rmargin may be the indent, in number of character spaces, if any, from the previous line. In some embodiment, the right margin feature may be a binary value, which is a function of whether the line extend to the right margin or not.

Other layout features are also contemplated, such as a vertical space between lines. For example, this may be expressed in terms of any variation from a standard line width.

In some embodiments, only the lmargin feature is employed as a layout feature.

Thus, for example, in FIG. 1, line 22 has a first token which is a hyphen. The length 34 of blank space between this character and the left margin 37 (which in this case corresponds to the start of the first character “a” on the previous line) is determined as a first layout feature having a lmargin value of 6 and the corresponding width 35 after the last character “:” to the standard line length may be assigned a rmargin value of 5.

In the exemplary embodiment, all lines of at least those sentences spanning three or more lines are assigned layout features (three being the minimum number of lines which can make up a list having a list introduction and a minimum of two list items). Thus, for example, line 39 may be assigned a lmargin feature value of 3 (character spaces).

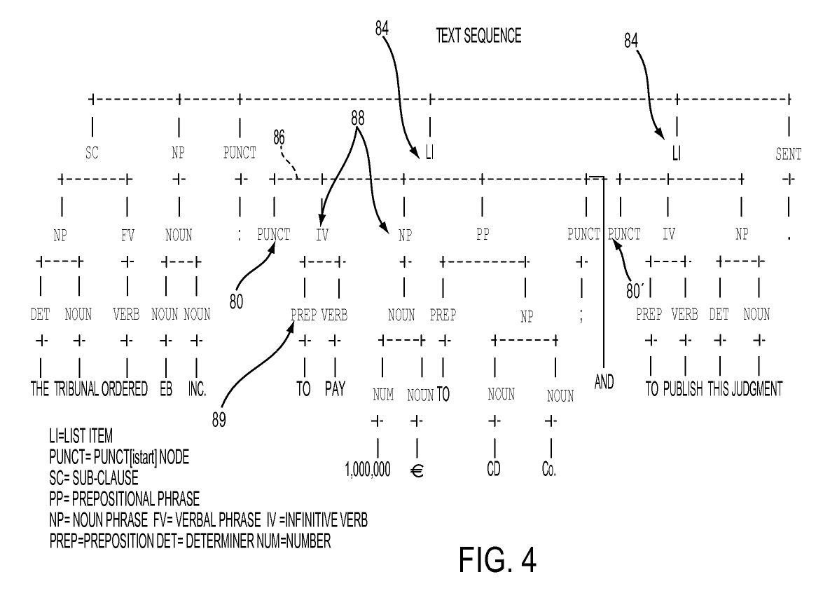

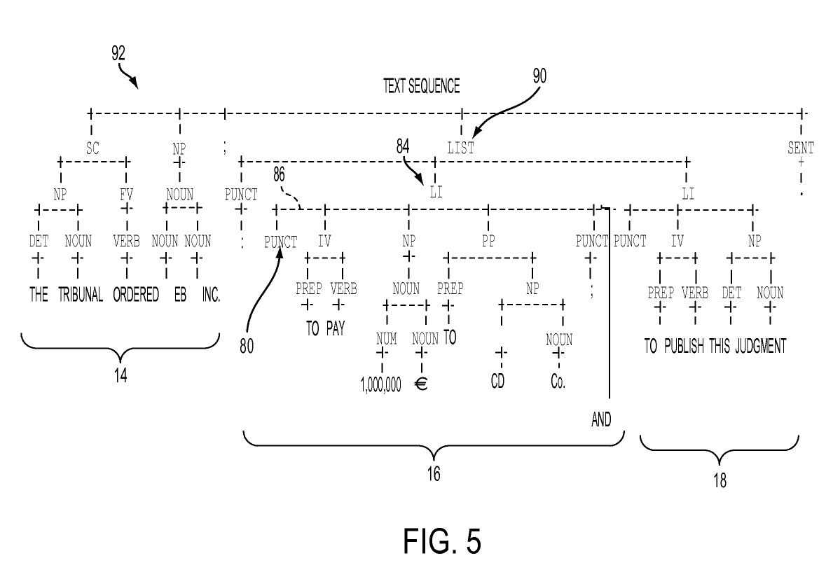

The entire sentence can be graphically represented as a tree, as illustrated in FIG. 4, which is refined throughout the method to produce the tree of FIG. 5. In the tree, information is associated with a set of nodes and the words of the sentence form the leaves of the tree, which are connected by pathways through the nodes. The tree structure applies standard constraints, such as requiring that no leaf or node has more than one parent node and that all nodes are eventually connected to a single root node corresponding to the entire sentence.

### Annotating Potential Labels (Starters) of List Items (S110)

This may be performed before the application of the regular chunking rules of the standard grammar. In this step, a candidate label of a list item is annotated with a node which includes non-linguistic features only.

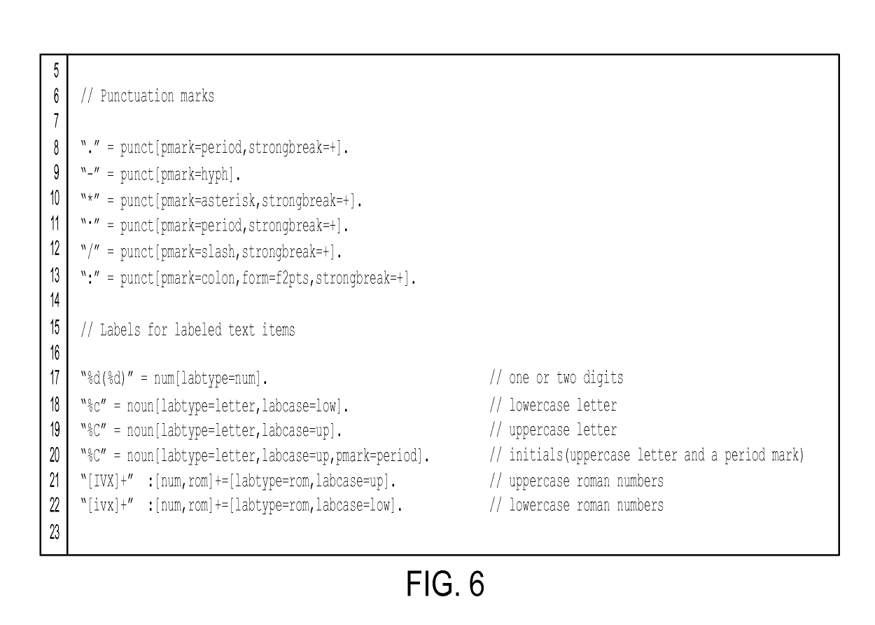

First, specific features are assigned to all tokens that can label list items, i.e., are among a predefined set of candidate list item tokens and are at the start of a new line (except the first line 76 of a document, since it cannot serve as a list item, only a list introducer). In particular, punctuation marks that can be list item labels may be assigned a specific nonlinguistic feature (pmark) with a value that denotes the identity of the mark (e.g., pmark=hyph for the hyphen symbol). Letters, initials, numbers and Roman numerals may also introduce list items and are thus candidate list item labels. These are each assigned a label type feature (labtype) and a label case feature (labcase), if appropriate. For example, token “2” on line 24 in FIG. 1 is assigned [labtype=num] to signify that it is a label of the “number” type. Similarly, a token “iv” would have the label features [labtype=rom,labcase=low] to signify a Roman numeral in lowercase. FIG. 6 lists other exemplary lexical definitions of labels. In FIG. 6, the characters // precede information for the user and are not part of the parser features. The label “noun” is given to any single letter (other than letters recognized a Roman numerals, such as “i”, “v”, and “x”) as it is the default label for all words. “Strongbreak” is a feature value which may be assigned to all punctuation that indicates a strong break, although it is not necessary to do so, since all accepted punctuation marks for the pmark feature are enumerated in the rules.

Thus, for example, in the rules shown in FIG. 6, the letter “a” and the number “12” are given labels if they start a new line but the number “120” and the two (or more) letters “an” in sequence are not. As will be appreciated, the rules exemplified in FIG. 6 may be language, domain, or even document specific and may be adapted to the type of lists typically encountered.

Then at each potential list item label, a node 80 is created (see, e.g., FIG. 4) with a category equal to PUNCT and with the specific feature istart=+, indicating that it is a potential list item start. The PUNCT[istart] node creation may be performed immediately after sentence segmentation and before the POS disambiguation and chunking of the standard parser grammar, with the following rules:

1. Create a PUNCT[istart] node on top of any sequence starting a new line and containing any of:
a. A first token with a labtype feature that is not a name initial and a second token with a pmark feature;
b. A first token with a labtype feature that is also a name initial (e.g. “A”), on the condition that it is not followed by a proper noun; and
c. A first token with a pmark feature.

2. Create an empty (dummy) PUNCT[istart] node on the left of any word or number starting a new line, if a punctuation mark occurs at the end of the preceding line and if it has a non-null left margin.

Rule 2 is for dealing with cases where list items start without punctuation or labels. In English, where list items often use the word “and” at the end of a penultimate list item, Rule 2 may be modified to accept a previous line punctuation mark that is followed immediately and only by “and” such as:

“; and” or “, and”.

In the above rules, a token with a labtype feature that is not a name initial may be, for example, a lower case letter, a lower case roman numeral, or a number, but not a single upper case letter or single upper case Roman numeral. A proper noun is a noun which is recognized as a name for a specific entity and which begins with a capital letter, such as “Smith.” Thus, for example, a sequence on a new line beginning with “V. Smith . . . ” is not given a PUNCT[istart] node (it does not fall under 1(c) above since the punctuation mark“.” is not the first token)). The tokens “a.”, “iiv.”, “and” and “12.”, for example, occurring at the start of a new line sequence, are all given PUNCT[istart] nodes.

The new PUNCT[istart] node may have some or all of the following features:

1. tcase (typographical case)—this is the case of the first word of the candidate list item, and the possible values are up (uppercase) and low (lowercase);

2. pmark (punctuation mark)—if a punctuation symbol starts (or ends) the candidate list item. The value of this feature can be the form of the punctuation symbol (hyphen, asterisk, period, bullet, etc.);

3. lmargin (left margin): the length in characters of the horizontal space before the first token of the candidate list item, or other measure of blank space;

4. labtype (alphanumeric label type): this is the type of the alphanumeric label, if any, with which the candidate list item is labeled. Possible values can be num (small integer number), letter, and rom (Roman numeral); and

5. labcase (alphanumeric label case): the typographical case of the label when the label type is letter or roman number.

These features are only exemplary and other sets of features may be employed, such as a set of two, three, four five, six or more such non-linguistic features. Rules may be applied which require that values of alphanumeric labels increase sequentially in a set of list items, although this is not necessary.

The PUNCT[istart] node may be an annotation on the text of the document, e.g., immediately preceding the first character of a line.

A PUNCT[istart] node 80 is only an indication of a possible start of a list item. Such nodes prepare for the recognition of list items and can prevent, in some cases, the chunking rules or named entity rules of the standard grammar 70 from building chunks that include list item labels and/or span over two successive list items.

Examples of PUNCT[istart] nodes 80 are now given for the list of FIG. 1:

a node PUNCT[istart,pmark=hyph,tcase=UP,lmargin=6] is created for each hyphen starting a candidate list item 16, 18, 20 in the main list,

a node PUNCT[istart,labtype=num,pmark=period,tcase=UP,lmargin=6] is created for each list item label (or starter) of candidate list items 24, 26, 28 of the embedded list (sub-list).

a node PUNCT[istart,pmark=NULL,tcase=UP,lmargin=6] (pmark=NULL indicates the absence of any punctuation mark) is created for candidate list item 21 (since the preceding line (not shown) ended with a punctuation mark). The sequence 39: “three newspapers of their choice;” does not receive a PUNCT[istart] node 80 because the first token three does not satisfy either of the rules 1 and 2 above.

For a list where items start with labels the PUNCT[istart] node will have the appropriate features, e.g.:

PUNCT[istart,pmark=slash,tcase=UP,lmargin=0,labtype=letter,labcase=LOW]

indicates alphabetic labels in lowercase letters with an indent of 0, having a “slash” mark, for list items starting in uppercase.

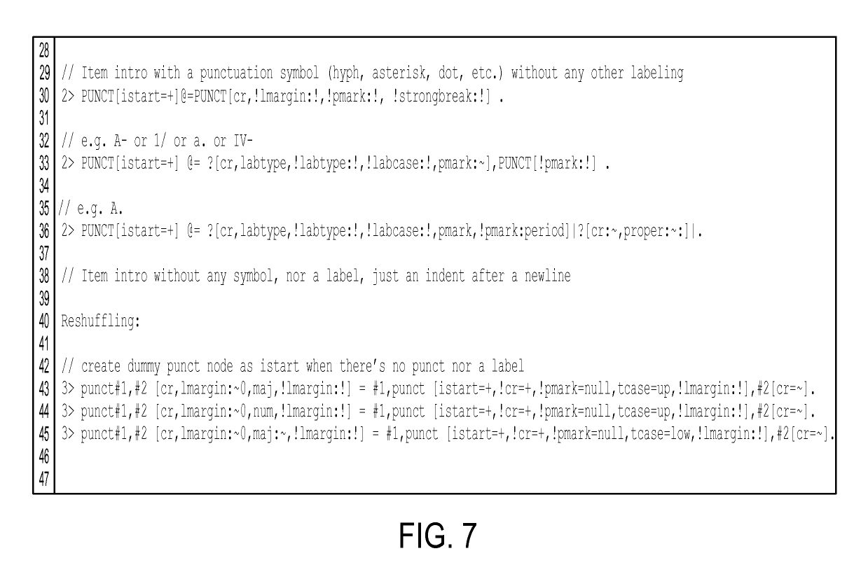

FIG. 7 shows exemplary parser rules that can be used to create PUNCT[istart] nodes. In the rules illustrated in FIG. 7, the feature cr indicates the first token after a new line. The symbol @ indicates the longest match which satisfies the rule. For example, two punctuation marks may be accepted, such as “-:”. (hyphen followed by a period.) However, in the given example rules FIG. 1 (line 30, 33 and 36), only one token is matched at once, because the right parts of the rules are not ambiguous in length, so only one punctuation is accepted. The symbol ˜ indicates not equal to. In the reshuffling step, nodes can be created or removed. Dummy nodes can be built. In the above example, these are built only when there is a layout feature—in this case, a left margin which is not equal to the standard line indent of 0.

The dummy PUNCT[istart] node rules exemplified are as follows: Rule line 43: creates a dummy PUNCT[istart=+, . . . ] node between any punct immediately followed by a token that comes after a newline (cr:+), starts with an uppercase letter (maj) and is indented (lmargin:˜0). The created dummy PUNCT[istart=+, . . . ] node gets the feature tcase=up. Rule line 44 does the same if the token after a newline is a numeral (num). Rule line 45 does the same if the token after a newline starts with a lowercase letter (maj:˜). Here the created dummy PUNCT[istart=+, . . . ] node gets the feature tcase=low.

At the end of this step, some of the layout, punctuation and other non-linguistic features have been associated with PUNCT[istart] nodes 80 and some lines of text may have no PUNCT[istart] node 80, because their features do not satisfy the rules for a PUNCT[istart] node (e.g., in FIG. 1, lines 39 and 78 are the only lines not to be given a PUNCT[istart] node).

### Building List Item Nodes (LI) (S114)

List item nodes LI 84 may be built at S114, after the regular chunking phase of the standard grammar has created sequences of linguistic nodes (S112), such as the node sequence 86 which includes linguistic nodes 88 denoted by IV, NP, PP, and PUNCT, shown in FIG. 4. In the exemplary embodiment, LI nodes 84 are built on top of only those sequences of nodes that start with a PUNCT[istart] node 80 (built in S110) and subject to one or more constraints, which may be at least partly language dependent, such as the following constraints:

1. The node sequence 86 does not directly contain another PUNCT[istart] node (i.e., the method finds the most embedded list first);

2. If the PUNCT[istart] 80 of the node sequence has [pmark=NULL] (no punctuation mark) and no labtype feature (no alphabetic, numeric or Roman numeral label), then the sequence is preceded by a punctuation mark (i.e., from the list introduction 14); and

3. The node sequence 86 is followed by another PUNCT[istart] 80′ having the same features, in this case the same (pmark, tcase, lmargin, labtype, labcase) features, as the PUNCT[istart] 80 of the considered node sequence, or it is preceded by an LI node having the same features (this ensures that each list has at least two list items).

The constraints may be at least partially language dependent.

An LI node 84 inherits, from its starting PUNCT[istart] node 80, all the features (pmark, tcase, lmargin, labtype, labcase).

An LI node 84 is also assigned a linguistic feature functype (function type). The value of the linguistic feature is the syntactic function that the main linguistic element in LI 84 can have according to the active element in the candidate list introduction 14. The main linguistic element in LI can be, for example, a noun phrase (NP), a verb (VB), a prepositional phrase (PP), or the like. The exemplary parser 70 includes rules for identifying the main linguistic element. Its syntactic function can be selected from a predefined set of syntactic functions, such as subject, direct object, indirect object, verb modifier, preposition object, etc. Thus the value of the feature function is also drawn from a finite set of values corresponding syntactic functions which can be in a relation with such syntactic functions, but further limited to those which can be in a syntactic relation with the active element of the candidate list introduction.

This step may involve:
1. identifying a candidate list introduction 14 sequence (this is the sequence of nodes immediately preceding the candidate list item LI 16 being considered, and which is at the same level of the chunking tree, e.g. in the tree of FIG. 4, this is the sequence of three nodes SC, NP, PUNCT (and their content) that precedes the sequence of the (candidate) LI nodes);
2. identifying the active element(s) of the candidate list introduction (MEIN) using parser rules;
3. identifying the possible syntactic functions that the MEIN can have from a predefined set of syntactic functions;
4. identifying the set of one or more possible syntactic relations in which the identified MEIN possible syntactic functions can participate;
5. identifying the main element in the candidate list item (MELI) using parser rules;
6. identifying possible MELI syntactic function(s) from a predefined set of syntactic functions;
7. identifying those of the possible MELI syntactic functions that can be in any of the possible syntactic relations with the MEIN; and
8. associating these MELI syntactic function(s) with the list item.

In the exemplary embodiment, the active element of a candidate list introduction (which is identified by the parser rules 70), is often the head of a linguistic element and, where found, may be a finite verb (which can be in a relation with a verb modifier, for example). If no finite verb is found in the candidate list introduction, the active element can be a noun phrase or a prepositional phrase. For example, in FIG. 1, the list item 18 has the same set of features as list item 16. Having found two candidates with the same non-linguistic features, a candidate list introducer is found in the text 14 immediately preceding the first candidate 16. This includes the sequence: plaintiff CD Co. requests the Tribunal to: The active element is the verb phrase requests, which can have a linguistic function of finite verb. This particular linguistic function can be in a syntactic relation with a main element in LI having a linguistic function such as: a verb modifier, a direct object, a preposition object, an indirect object, etc. The actual set of possible syntactic functions depends on the predefined set of syntactic functions of the parser in use. The main element of the list items 16, 18 is a verb which can serve as a verb modifier (specifically, an infinitive complement in this case). Since verb modifier is an acceptable linguistic function in this case, this linguistic function may thus be associated with LI as a functype feature. While the exemplary functype features are general classes of linguistic functions, such as direct object, verb modifier, etc., more restrictive feature types are contemplated. For example, given the list:

Bob likes the following fruits:
apples,
pears, and
oranges.

In this example, the parser list rules 72 may be configured to identify the semantic class fruits, rather than simply direct object and to associate the active element of a candidate list introduction with this class, thereby requiring LI's functype feature to be, for example: object class fruit.

After these LI chunking rules are applied by the parser, the sentence chunking tree contains both linguistic chunk nodes (NP, PP, SC, etc.) and the LI nodes. As an example, given the following simplified sentence:

The Tribunal ordered ABC Company:
to pay 1,000,000 Euros to CD Company; and
to publish the judgment.

is arranged in the syntactic tree structure illustrated in FIG. 4. As can be seen, there are two LI nodes 84, each having a PUNCT[istart] node 80 and at least one other, linguistic node 88 as child nodes in the tree. As will be appreciated, the linguistic nodes 88 may also have child nodes 89. Data, in this case, words, numbers and other tokens, are associated with respective linguistic nodes (only the most terminal linguistic nodes in the tree).

### Building LI Modifiers (S116)

LI modifiers (LIMOD) nodes are built with chunking rules that match any sequence of nodes between two candidate LI nodes, with the condition that the sequence is not a main finite-verb clause. This includes sequences of NP, PP, AP, ADV and PUNCT nodes. E.g., “In consequence:” will have the node sequence: PUNCT[istart],PP,PUNCT, which is surrounded by LI nodes, and the main element of this node sequence is the PP “In consequence”, which is not a finite-verb clause.

### Building List Nodes (LIST) (S118)

At S118, a list is built which includes two or more candidate list items (now considered list items), each list item having a set of features which is compatible with the set of features of each of the other list items. In particular, LIST nodes 90 (FIG. 5) may be built on top of sequences of two or more LI nodes (including any identified LI modifiers) that have the same (or compatible) linguistic and non-linguistic features: pmark, tease, lmargin, labtype, labcase, and functype. In parser language, this constraint may be expressed as the unification of free features, which are indicated with the “!” mark in the rule example in FIG. 8.

The method can include comparing the set of features of two candidate list items to determine whether they are compatible (same or meet at least a threshold similarity). In some embodiments, to be considered compatible may require an exact match between the sets of features, i.e., that their values are identical for the two candidate list items to be considered list items in the same list. For example, each of the features has the same value for one list item as for another list item. In other embodiments, the constraint on compatible LI features can be weakened by choosing a subset of the LI features on which the constraint applies. For example, in the case of scanned documents, the left margin may not always be accurately determined by the OCR engine, and thus an lmargin feature may permit some variation, such as 6±1 of 6±2 (character spaces). In some embodiments, a minimum quantity (number or proportion) of the nonlinguistic features is required for the LI features to be considered compatible. The threshold for compatibility may depend, for example, on the writing conventions in the document collection to parse and on the relative importance of precision and recall for a given application. In general, for two list items to be compatible, the functype feature value(s) should be the same. For example, if the list introducer requires a direct object, both list items have a direct object among their functype features and both have an element which can serve as a direct object.

FIG. 5 shows the unified linguistic and list tree structure 92 which can be obtained for the simplified example sentence above in which the new list node 90 is added on top of a set of compatible list item nodes 84.

Extraction of Syntactic Relations within List Structures (S122)

Syntactic relations between elements of the list(s) 12 can now be extracted using parser dependency rules and the constraints on the list structure 92, built in the preceding steps. Consider, for example, the subject relations that may hold between an entity in a list introduction 14 and each of its list items 16, 18, 20. For example, the noun phrase “The Tribunal” in the list introduction 14 of FIG. 1 is the subject of the infinitive verbs (order, authorize, order) of the main heads of each list item 16, 18, 20 in the list 12. The following exemplary dependency rule extracts all the required subject relations:

```
|SC{ FV{?*,#1[last,infctrl:obj]}}, NP{ ?*,#2[last]}, ?*[list:~],
  LIST{(punct), LI*, LI{punct, IV{ ?*,#3[last]}}} |
    COMP(#1,#3),
    SUBJ(#3,#2).
```

This rule says if:

the list introduction is a clause which has a main finite-verb with the feature “infctrl:obj” (infinite control=object), which means the verb accepts a direct object and an infinitive complement, and the element that “controls” the infinitive (i.e., its “subject”) is the object of the main verb (examples of such verbs are “order”, “request”, “ask” etc. for instance: “John orders Paul to work”, “orders” has an object (“Paul”) and an infinitive complement (“to work”), and the subject of the infinitive “to work” is the object of “orders”, i.e., “Paul”0;

the main finite verb is followed by an NP the head of which is assigned to variable #2 (hence #2 is the direct object of the main finite verb); and

the list introduction is followed by a sequence of LIs, and each of them starts with an infinitive verb (IV) the head of which is assigned to variable #3;

then extract a dependency relation COMP (complement) between main verb #1 and the infinitive verbs #3 of each LI, and a SUBJ (subject) relation between the infinite verb #3 of each LI and the object #2 of the main verb.

As will be appreciated, such rules would not apply on sentences with no list structures. Thus, they do not interfere with the rules of the standard grammar, and do not change the parser output on normal sentences.

Thus for example, the following subject relations are extracted with this rule from the tree structure 92 of FIG. 5:

COMP(ordered, pay)

SUBJ(pay, EB Inc.)

and

COMP(ordered, publish)

SUBJ(publish, EB Inc.)

The sentence 12 can be tagged with these relations and/or information extracted therefrom can be output.

The exemplary method has several advantages over existing methods for processing text that tends to include lists. These include:
1. Since list structures are (at least partially) determined by linguistic structure, and vice versa, recognizing both types of structure in the same parsing process allows for the co-specification of properties that determine the building of these structures;
2. Only one tool (namely, the NLP parser 70 incorporating list rules 72) is needed for extracting dependency relations between elements in lists, and no markup nor any other kind of automatic or semi-automatic preprocessing of lists in the input text is needed;
3. The sub-grammar 72 dedicated to lists can be developed and maintained without modifying the standard (core) grammar 70 of the parser, when implemented in an incremental sequential parser.

As will be appreciated, the exemplary method is language-dependent and processing lists in a new language may involve list-related rules being adapted or new ones created which are appropriate to the given language. This is not a significant problem since the core grammar has to be created for each language in order to extract syntactic relations, thus syntactic relation rules specific to list structures can often be adapted from these.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for extracting information from text, the method comprising:
providing parser rules adapted to processing of lists in text, each list including a plurality of list items linked to a common list introducer, and a computer processor for implementing the parser rules;
receiving text from which information is to be extracted, the text including lines of text;
segmenting the text into sentences;
for one of the sentences, providing for, with the parser rules:
identifying a set of candidate list items in the sentence, each candidate list item being assigned a set of features, the features comprising a non-linguistic feature and a linguistic feature, the linguistic feature defining a syntactic function of an element of the candidate list item that is able to be in a dependency relation with an element of an identified candidate list introducer in the sentence; and
generating a list which includes a plurality of list items, comprising:
identifying list items from the candidate list items which have compatible sets of features, and
linking the list items to a common list introducer;
extracting dependency relations between an element of the list introducer and a respective element of each of the plurality of list items of the list; and
outputting information based on the extracted dependency relations.

2. The method of claim 1, wherein the identifying of the set of candidate list items, generating the list, and extracting dependency relations are all performed with a syntactic parser.

3. The method of claim 1, wherein the non-linguistic feature comprises a set of non-linguistic features.

4. The method of claim 1, wherein the non-linguistic feature comprises at least one feature associated with a line of text of the candidate list item.

5. The method of claim 1, wherein the non-linguistic feature comprises at least one of a layout feature, a punctuation feature, and a label feature.

6. The method of claim 5, wherein the non-linguistic feature comprises a layout feature which is based on a measure of blank space at one end of a line of text of the candidate list item.

7. The method of claim 1, wherein the identifying of the set of candidate list items comprises assigning non-linguistic features to each of a set of lines of text in the sentence, the non-linguistic features being selected from a set of feature types selected from the group consisting of:
a left margin feature based on a length of the horizontal space before a first token of the candidate list item;
a typographical case feature based on a typographical case of a first word of the candidate list item;
a punctuation mark feature which is assigned when a punctuation symbol starts the candidate list item; and
an alphanumeric label type feature based on a type of alphanumeric label, if any, with which the candidate list item is labeled and, optionally, a label case feature based on a typographical case of the label when a label type has more than one case.

8. The method of claim 7, wherein the assigning of non-linguistic features comprises applying parser rules for assigning each of the feature types to relevant tokens of candidate list items.

9. The method of claim 7, wherein the method comprises creating a node on top of any sequence starting a new line which meets a set of constraints which take into account its assigned features, the candidate list items each being based on features of a respective node.

10. The method of claim 9, wherein the constraints create a node for a sequence with any one of:
a. a first token which has been assigned an alphanumeric label type feature that is not a name initial and a second token which has been assigned a punctuation mark feature;
b. a first token which has been assigned a label type feature that is also a name initial on the condition that it is not followed by a proper noun; and
c. a first token which has been assigned a punctuation mark feature.

11. The method of claim 10, further comprising creating a node on the left of any word or number starting a new line, if a punctuation mark occurs at the end of the preceding line.

12. The method of claim 1, wherein the candidate list items each comprise a line of text.

13. The method of claim 1, wherein the segmenting of the text into sentences comprises applying rules for segmenting the text which ignore at least some punctuation at the start of lines of the text.

14. The method of claim 1, further comprising providing for identifying a list item modifier, each list item modifier addressing a temporary break in a list between a first of the list items and a second of the list items.

15. The method of claim 14, further comprising, for an identified list item modifier, extracting a dependency relation between an element of the list item modifier and an element of the list introduction, or between an element of the list item modifier and an element of list items that follow the list item modifier in the same list.

16. The method of claim 1, wherein the method further comprises providing for identifying sub-lists, each sub-list comprising a sub-list introducer and a plurality of sub-list items, wherein each sub-list item is defined by a set of features, the features comprising a non-linguistic feature and a linguistic feature, the linguistic feature defining a dependency relation between an element of the sub-list item and an element of a candidate sub-list introducer in the sentence, the sub-list items and sub-list introducer being in the same one of the plurality of list items.

17. The method of claim 1, wherein the identifying of the set of list items with compatible features comprises comparing the features of two candidate list items to determine whether they meet at least a threshold similarity and if so, adding them to the set of list items.

18. The method of claim 1, wherein the identifying of the candidate list items comprises, for each of a plurality of lines of text in the sentence:
assigning layout features to the lines of text;
identifying potential list item labels and annotating them with punctuation nodes, each of the punctuation nodes comprising only non-linguistic features;
propagating the features of the punctuation nodes to respective list item nodes; and
associating a linguistic feature with each list item node.

19. The method of claim 1, wherein the syntactic function of an element of the candidate list item is selected from the group consisting of subject, direct object, indirect object, verb modifier, and preposition object.

20. The method of claim 1, wherein the method is performed without prior knowledge as to whether the text includes a list.

21. A computer program product comprising a non-transitory recording medium encoding instructions, which when executed on a computer causes the computer to perform the method of claim 1.

22. A system for processing text comprising instructions stored in memory for performing the method of claim 1 and a processor in communication with the memory for implementing the instructions.

23. A system for processing text comprising:
a syntactic parser which includes rules adapted to processing of lists in text, each list including a list introducer and a plurality of list items, the parser rules including rules for:
without prior knowledge as to whether the text includes a list, identifying a plurality of candidate list items in a sentence, each candidate list item being assigned a set of features, the features comprising a non-linguistic feature and a linguistic feature, the linguistic feature defining a dependency relation between an element of a respective candidate list item and an element of a candidate list introducer in the sentence,
generating a list from a plurality of list items with compatible feature sets; and
extracting a dependency relation between an element of the list introducer and a respective element of a list item of the list; and
a processor which implements the parser.

24. A method for processing text, the method comprising:
for a sentence in input text, providing parser rules for:
identifying candidate list items in the sentence, each candidate list item comprising a line of text and an assigned set of features, the features comprising a plurality of non-linguistic features and a linguistic feature, the linguistic feature defining a linguistic function of an element of the candidate list item which can be in a dependency relation with an element of a candidate list introducer in the same sentence;
generating a tree structure which links a list introducer to a plurality of list items, the list items selected from the candidate list items based on compatibility of the respective sets of features; and
implementing the rules on a sentence with a computer processor.
